(19) United States
(12) Patent Application Publication
(10) Pub. No.: US 2006/0257140 A1
(43) Pub. Date: Nov. 16, 2006

(54) Device and method for generating images

(76) Inventors: Ulrich Seger, Warmbronn (DE); Uwe Apel, Neckartailfingen (DE); Jens Schick, Herrenberg (DE); Bjorn Abel, Geseke (DE); Michael Burg, Lippstadt (DE); Joerg Heerlein, Regensburg (DE)

Correspondence Address: KENYON & KENYON LLP, ONE BROADWAY, NEW YORK, NY, 10004, US

(21) Appl. No.: 10/544,406

(22) PCT Filed: Nov. 8, 2003
(86) PCT No.: PCT/DE03/03711

§ 371 Date: May 4, 2006

(30) Foreign Application Priority Data
Feb. 7, 2003 (DE) 103 05 009.4

(51) Int. Cl. G03B 19/00

(52) U.S. Cl. 396/429

(57) ABSTRACT

A method and a device for generating images in a motor vehicle. An infrared-sensitive camera generates images of the surroundings of the motor vehicle, line by line in scanning lines. The image recording region of the infrared-sensitive camera is illuminated in pulsed fashion by at least one emission source that radiates in the infrared spectral region. The recording of the scanning lines is carried out synchronized in time with the pulsed illumination. In a first example embodiment, the recording of scanning lines of an infrared-sensitive CMOS camera is synchronized in time with a laser diode emitting in the near infrared spectral region. In a second example embodiment, the synchronization in time of the recording of scanning lines of the infrared-sensitive CMOS camera with the pulsed illumination is performed autonomously by the CMOS camera by evaluation of at least one recorded scanning line.

### BACKGROUND INFORMATION

During night driving in a motor vehicle, the reduced range of vision caused by the limited reach of the passing beam places heightened requirements on the driver. Because of the introduction of gas discharge headlights having greater light emission, in recent times, better illumination of the roadway has been achieved, compared to usual headlights. However, the visual range is even limited when using these new headlights, and therefore, to improve vision, it is planned to use night vision systems in motor vehicles.

In night vision systems, a distinction is made between passive and active night vision systems. Passive night vision systems are made up of a heat image camera. The disadvantage of passive night vision systems is that it is difficult to produce images that are true to life. By contrast, active night vision systems are made up of an infrared emitting illumination unit, such as a halogen light having a filter, and one or more infrared-sensitive cameras. The illumination unit irradiates the vehicle's near field in the high beam region and the cameras photograph the reflected infrared high beam and reproduce the image on a monitor or a head-up display. In this context, headlights may be used for the visible passing beam and high beam to emit infrared light. However, the motor vehicle industry is increasingly planning proportionately to replace infrared-emitting halogen headlights with infrared-free xenon headlights. By their doing this, the use of additional infrared-emitting radiation sources becomes necessary. As the additional infrared-emitting radiation sources, the use of infrared-emitting lasers is possible, for example.

German Patent No. DE 42 43 200 C2 describes a device for friend/foe identification of ground vehicles for military applications. In order to make visible occulted signatures for friend/foe identification, a heat image camera is linked to a CO₂ laser. An observer emits a single light pulse and the infrared camera receives the reflected signal in synchronized fashion. A disadvantage of this device is that heat image cameras do not deliver true-to-life images. What is missing in DE 42 43 200 C2 is any hint at a device or a method for generating images that are true to life and would be suitable for use in motor vehicles.

### SUMMARY

An example device and method, described below, for image generation in a motor vehicle, using at least one infrared-sensitive camera, images being generated scanning line by scanning line, synchronized with the pulsed illumination of the surroundings of the motor vehicle, may have the advantage that true-to-life images having high image quality may be generated in both good and bad visibility conditions and/or weather conditions. The example device and the method for generating images may, because of the high image quality of the images generated, in an especially advantageous manner contribute to a reduction in accident numbers during bad visibility conditions, especially by night. The generation of true-to-life images having a high image quality at poor visibility conditions and/or weather conditions is achieved because the illumination of the image-recording range using an emission source that emits at least in the near infrared spectrum range is not significantly interfered with by rain or snow.

It is advantageous that the service life of the at least one emission source emitting at least in the infrared spectrum range is increased by the pulsed light output. In pulse operation, at the same output, there is a lower thermal load on the emission source compared to continuous operation. This directly leads to an increase in service life. A longer service life of the emission source, and longer replacement intervals connected therewith, contribute in an advantageous manner to a reduction in operating costs in a motor vehicle.

At the same time, the pulse operation of the at least one infrared-radiating emission source makes possible a substantially higher intensity of radiation during the light pulse, at the same average intensity of radiation of the mission source. In this context, the intensity of radiation is established as the output per solid angle. In connection with this, the irradiation level, that is, the output per area of the irradiated area is increased during the light pulse, compared to continuous, unpulsed light output. Because of this, in an especially advantageous manner, an intensive illumination is achieved of the image recording range of the at least one infrared-sensitive camera.

Particularly advantageous is at least one infrared-sensitive CMOS camera for generating at least one image of the surroundings of the motor vehicle. As opposed to other camera types, in CMOS cameras the blooming effect is reduced. By blooming, in this context, is understood halation of the generated image by glare having strong light sources.

By using at least one infrared-radiating laser and/or at least one infrared-radiating laser diode, in a particularly advantageous manner, pulsed illumination of the image recording range of the at least one infrared-sensitive camera is made possible in a simple manner. For example, by a short response behavior, laser diodes make it possible to generate short light pulses at a simultaneously high intensity of radiation during the light pulse duration. Furthermore, infrared-radiating lasers and/or infrared-radiating laser diodes have the advantage that the laser light has a low spectral bandwidth. By appropriate band-pass filters in front of the at least one infrared-sensitive camera it is thereby possible to filter out other spectral ranges. For example, in the case of oncoming motor vehicles which, for instance, are traveling at night, using passing lights, it is thereby possible to filter out this visible passing light that interferes with the image generation. In an advantageous manner, the use of at least one infrared-radiating laser and/or at least one infrared-radiating laser diode contributes to the generation of images having a high image quality. Besides that, infrared-emitting lasers and/or infrared-emitting laser diodes have the advantage that they have a high efficiency.

The at least one emission source radiating at least in the near infrared spectrum region generates light pulses. Advantageous are pulse durations of the light pulses of less than 100 ns, especially between 10 and 80 ns. These short pulse durations contribute to an increase in the image quality of the generated image. Alternatively or in a supplementing fashion, it is of advantage to generate the light pulses to have a duty cycle of less than 0.1%. These measures make it possible to generate a high irradiation level during the light pulse and thereby to achieve a good image quality of the images.

In a scanning line-wise synchronization, the recording of scanning lines of the at least one infrared-sensitive camera is synchronized in time with the pulsed illumination. In this context, the synchronization in time is carried out for each scanning line or for a sequence of at least two scanning lines. By this scanning line-wise synchronization in time of the recording of the scanning lines with the pulsed illumination, a secure and stable synchronization in time is achieved in an advantageous manner. By contrast, the image-wise or image sequence-wise synchronization in time has the advantage that the technical effort for the synchronization is reduced. The synchronization in time takes place for at least one image in the case of the image-wise or image sequence-wise synchronization in time. This scanning line-wise or image-wise or image sequence-wise synchronization is achieved by unidirectional or bidirectional synchronization signals on at least one synchronization line between the at least one infrared-sensitive camera and the at least one emission source radiating at least in the near infrared spectral region. It is particularly advantageous that the synchronization in time is able to take place via at least one communications data bus in the motor vehicle, for example, the CAN bus. In an advantageous manner, this saves having additional synchronization lines, and utilizes the existing infrastructure for data exchange in the motor vehicle.

Especially advantageous is the autonomous synchronization in time of the at least one infrared-sensitive camera with the pulsed illumination, since no separate synchronization line is needed between the at least one infrared-sensitive camera and the at least one emission source radiating at least in the near infrared spectral region. This has the advantage that the example device and method described below are thereby made resistant to interference because the individual components function independently of one another. One variant of the example device and method, described below, has particular advantages in that the recording of the scanning lines may be displaced in time with respect to the pulsed illumination. Thereby it is possible, for example, to adjust running time effects of the radiation from the light pulse output to the detection by the camera. This contributes to images having high image quality.

Another variant of the device and method described below is advantageous, in which the synchronization in time is carried out as a function of at least one image quality measure. By the calculation of at least one image quality measure, for one thing, the setting of the shift in time between the recording of the scanning lines and the pulsed illumination is made possible in automated fashion. This also contributes to images having a high image quality, since the exposure of the images in the entire image region and an image sequence is constant. Besides that, the determination of at least one image quality measure makes possible the autonomous synchronization in time of the at least one infrared-sensitive camera with the pulsed illumination, since, in the case of a worsening of the image quality measure, a shifting of the recording of the scanning lines with respect to the pulsed illumination may be carried out to achieve a high image quality measure.

Further advantages will become apparent from the following description of exemplary embodiments with reference to the figures.

### BRIEF DESCRIPTION OF THE DRAWINGS

The present invention will be explained in more detail below with reference to the example embodiments shown in the figures.

FIG. 1 shows a general plan of a first example embodiment.

FIG. 2 shows a block diagram of the first example embodiment.

FIG. 3 shows a time diagram for the first example embodiment.

FIG. 4 shows a general plan of the second exemplary embodiment.

### DESCRIPTION OF EXAMPLE EMBODIMENTS

A method and a device for generating images in a motor vehicle are described below. An infrared-sensitive camera generates images of the surroundings of the motor vehicle, line by line in scanning lines. The image recording region of the infrared-sensitive camera is illuminated in pulsed fashion by at least one emission source that radiates in the infrared spectral region. The recording of the scanning lines is carried out synchronized in time with the pulsed illumination. In the first exemplary embodiment, the recording of scanning lines of an infrared-sensitive CMOS camera is synchronized in time with a laser diode emitting in the near infrared spectral region. In the second exemplary embodiment, the synchronization in time of the recording of scanning lines of the infrared-sensitive CMOS camera with the pulsed illumination is performed autonomously by the CMOS camera by evaluation of at least one recorded scanning line.

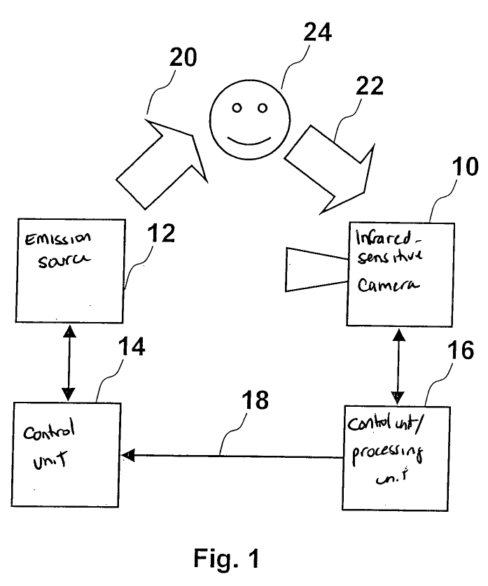

FIG. 1 shows a general plan drawing of a device for generating images in a motor vehicle of the first exemplary embodiment, made up of an infrared-sensitive camera 10 having a control unit/processing unit 16 and an emission source 12, that emits in the near infrared spectral region, having a control unit 14. Control unit/processing unit 16 of infrared-sensitive camera 10 and control unit 14 of emission source 12 are connected to each other via a signal line 18. Emission source 12 generates infrared radiation 20 in the near infrared spectral region for the pulsed illumination of the surroundings 24 of the motor vehicle. In this context, emission source 12 is installed in the front area of the motor vehicle, between the headlights for the passing light/high beam. As emission source 12 radiating in the near infrared spectral region, in the first exemplary embodiment, a laser diode radiating in the near infrared spectral region is used. Emission source 12 is controlled and monitored by control unit 14. From backscattered infrared radiation 22, infrared-sensitive camera 10 generates images of the surroundings 24 of the motor vehicle. Infrared-sensitive camera 10 is mounted behind the windshield of the motor vehicle in the area of the inside rearview mirror. In the first example embodiment, infrared-sensitive camera 10 is an infrared-sensitive CMOS camera 10. CMOS camera 10 is controlled via control unit/processing unit 16. At the same time, CMOS camera 10 transmits the generated images of surroundings 24 of the motor vehicle for further processing to control unit/processing unit 16.

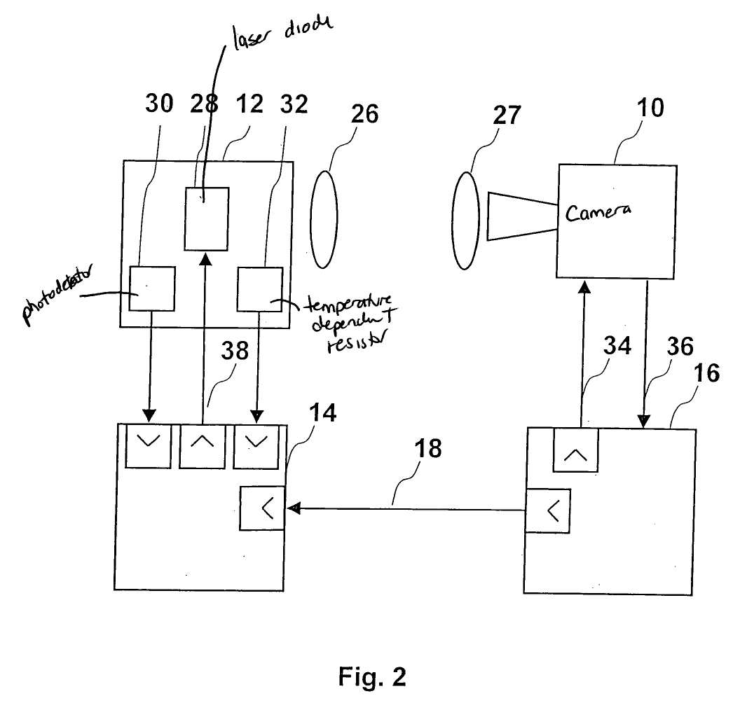

FIG. 2 shows a block diagram of the device for generating images in a motor vehicle of the first example embodiment. Below, we explain the components additional to the ones in FIG. 1 and the manner of functioning of the device. Emission source 12 radiating in the near infrared spectral region is made up of a laser diode 28 radiating in the near infrared spectral region, a photodetector 30 and a temperature-dependent resistor 32.

Laser diode 28 is controlled via signal line 38 for laser diode control as a function of measured values ascertained by photodetector 30 and temperature-dependent resistor 32. Photodetector 30 and temperature-dependent resistor 32 are used as measuring elements in a feedback branch for the controlled setting of the intensity of radiation and/or the time characteristic of the light pulse emitted by laser diode 28. Emission source 12 generates infrared radiation at least in the near infrared spectral region, preferably in the wavelength range between 850 nm and 900 nm. Subsequently, the generated infrared radiation is used, via an optical system 26, for the pulsed illumination of the image recording region of CMOS camera 10. Optical system 26 is used for the expansion of the generated infrared radiation in the vertical and the horizontal direction, in order to achieve as complete as possible an illumination of the image recording region of CMOS camera 10. The reradiated infrared radiation is recorded by infrared-sensitive CMOS camera 10 after being filtered by a filter 27. Filter 27 is a band-pass filter that transmits the wavelengths of the emitted infrared radiation, while it suppresses wavelengths that lie outside the passband. From the reradiated infrared radiation, infrared-sensitive CMOS camera 10 generates images of the surroundings of the motor vehicle and transmits the generated images to control unit/processing unit 16, via signal line 36. Infrared-sensitive CMOS camera 10 is made up of individual pixels which, in the first exemplary embodiment, are situated in a matrix including 640×480 pixels. Scanning lines are recorded line by line to generate an image. In this context, CMOS camera 10 temporarily stores the image signals line by line, so that light flashes emitted line by line by emission source 12 gradually illuminate the whole image, without radiating laser energy in exposure-insensitive phases. The line by line light sensitivity of CMOS camera 10 is also designated as “line shutter”. Via signal line 18 and signal line 34, control unit/processing unit 16 controls the synchronization in time between the line by line recording of the scanning lines and the pulsed illumination of the image recording region of CMOS camera 10. In the first example embodiment, a unidirectional synchronization in time is carried out. Control unit/processing unit 16 emits line signals to the CMOS camera via signal line 34. Synchronized with this, control unit/processing unit 16 transmits laser control signals to control unit 14 of emission source 12 via signal line 18. In response to each line signal that reaches the CMOS camera via signal line 34, in each case a scanning line is controlled in such a way that the scanning line is sensitive to optical information. The optical information is converted to image signals via a sample & hold circuit. After completion of the sampling procedure, the system switches automatically to the next scanning line or, when the last scanning line is reached, to the first scanning line of the matrix. In response to the subsequent line signal, the procedure described above is repeated, and the sampling procedure for this scanning line is carried out correspondingly. The image is finally assembled from the image signals of each pixel of all scanning lines. From the laser control signals that are transmitted via signal line 18, control unit 14 generates a laser control current which is used via signal line 38 to activate the laser diode for the direct control of laser diode 28. Possible phase shifts between the pulsed illumination of the image recording region of CMOS camera 10 and the line-wise recording, to be synchronized in time, of the scanning lines may be adjusted by a displacement in time of the pulses, that is, of the line signals and of the laser control signals to CMOS camera 10 and control unit 14. As cause of the phase shift one might name time delays in the generation of light pulses and running time delays of the light pulse. This shift may be set fixedly, specific as to type, that is, as a function of the individual components used, or it is ascertained via an image quality measure. The image quality measure is ascertained via an image evaluation in the control unit/processing unit 16 via the brightness of the image and/or the brightness gradient in the image edges, that is, in the direction from the first scanning line to the last scanning line. The displacement in time is set optimally in control unit/processing unit 16, as a function of the image quality measure ascertained, via an appropriate regulation.

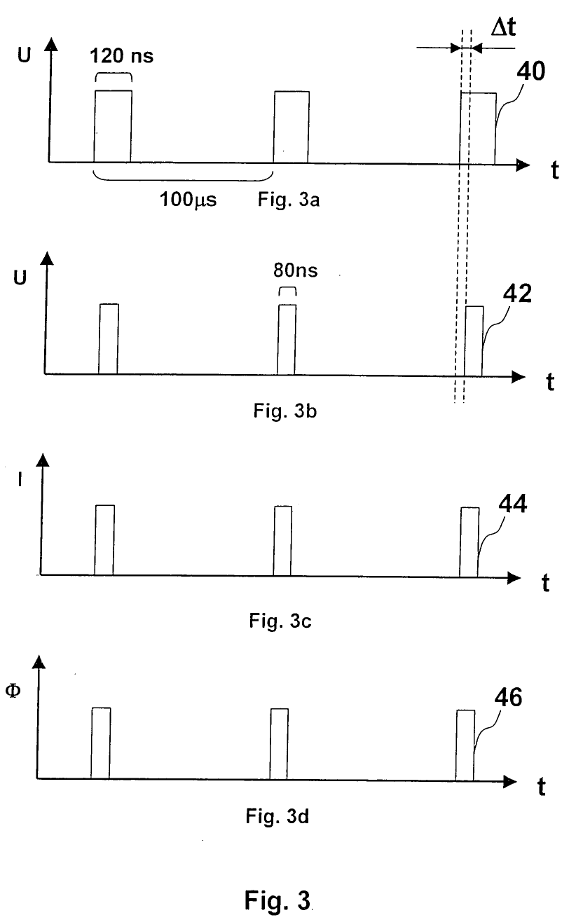

FIG. 3 shows in each case a time diagram, for the first exemplary embodiment, of signals 40, 42, 44 on signal lines 34, 18, 38 as in FIG. 2, as well as the time characteristic of laser pulse 46 of infrared radiation 20 as in FIG. 1. FIG. 3 reflects the pattern, in principle, of signals 40, 42, 44 and of laser pulse 46. On the abscissas of FIGS. 3a, 3b, 3c, and 3d, time t is plotted in each case. FIG. 3a shows the time characteristic of voltage U of line signals 40 on signal line 34 as in FIG. 2. A pulse lasting about 120 ns is generated as line signal 40, having a period of 100 μs. Line signal 40 is used as a signal for carrying out the sampling procedure and, at the same time, for the selection of the next scanning line for the CMOS camera. FIG. 3a shows the time characteristic of voltage U of laser control signals 42 on signal line 18 as in FIG. 2. A pulse lasting about 80 ns is generated as laser control signal 42, having a period of 100 μs. Laser control signal 42 is used as a signal for control unit 14 as in FIG. 2, which, as a function of this laser control signal 42, generates laser control current 44, which is then converted by infrared-radiating emission source 12, as in FIG. 2, to a laser pulse 46. FIG. 3c shows the time characteristic of current I of laser control current 44 on signal line 38 as in FIG. 2. Finally, FIG. 3d shows the time characteristic of radiant flux Φ of laser pulse 46. In FIGS. 3a and 3b the time displacement Δt between the start of the pulse of line signal 40 and the start of the pulse of laser control signal 42 is drawn in. In the first exemplary embodiment, this time displacement Δt is set in such a way that the pulse of laser control signal 42 lies symmetrically in the middle of the pulse of line signal 40. Time displacement Δt accordingly amounts to approximately 20 ns in the first example embodiment.

In one variant of the first example embodiment described above, image synchronization pulses are emitted by control unit/processing unit 16, as in FIG. 2, via signal lines 18 and 34. Image synchronization pulses determine the start of the line-wise image taking in the first scanning line. Infrared-sensitive CMOS camera 10 generates line signals 40 itself, triggered by the image synchronization pulse, with the aid of its own timing pulse generator. Analogously to this, control unit 14 generates laser control signal 42 itself, also triggered by the image synchronization signal with the aid of its own timing pulse generator. Quartzes, for instance, are used as timing pulse generators. In one additional variant, the synchronization in time is carried out by image sequence. This means that an image sequence synchronization pulse is generated, for instance, after ten images and CMOS camera 10 and control unit 14 meanwhile generate line signals 40 and laser control signals 42 themselves by their own timing pulse generator. Another variant of the example embodiments described above provides carrying out the synchronization in time in a bidirectional manner.

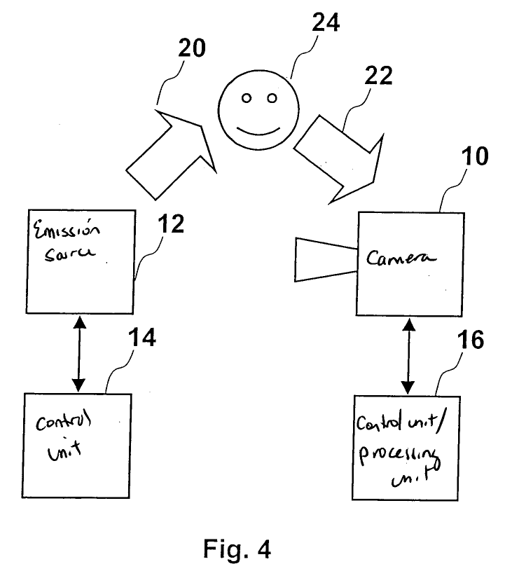

FIG. 4 shows a general plan drawing of a device for generating images in a motor vehicle of the second example embodiment, made up of an infrared-sensitive camera 10 having a control unit/processing unit 16 and an emission source 12, that emits in the near infrared spectral region, having a control unit 14. Below, we shall only describe the differences in the construction and the functioning of FIG. 4 compared to FIG. 1.

In contrast to the first example embodiment shown in FIG. 1, there is no synchronization line. The synchronization in time between the line-wise recording of scanning lines and the pulsed illumination takes place by ascertaining an image quality measure explained above by control unit/processing unit 16. As a function of the ascertained image quality measure, control unit/processing unit 16 generates the start of the line signal, with the aim of achieving a high image quality measure. In this context, a pulse pattern of emission source 12 supports the search for the start of the line signal with the aid of the image quality measure. In this connection, a pulse pattern is understood to mean a swept frequency change of the laser pulses. Alternatively or in supplement, the search is supported by a systematic frequency displacement of the line signal and/or the image synchronization pulse and/or the image sequence synchronization pulse.

In one variant of the example embodiments and the variants described above, the infrared-sensitive camera and control unit/processing unit of the camera form one unit. Alternatively or in supplement, the emission source radiating at least in the near infrared spectral region and the control unit of the emission source are one unit.

In one further variant of the example device and method described above, generally at least one infrared-sensitive camera is used which has means for recording scanning lines line by line. In one variant, besides an infrared-sensitive camera, at least one additional infrared-sensitive camera is used, especially at least one infrared-sensitive CMOS camera. Besides the matrix size of the camera of 640×480 pixels (VGA format) used in the above exemplary embodiments, in additional variants, infrared-sensitive cameras are used having a matrix size of, for instance, 352×268 pixels (CIF format) and/or 1024×768 pixels and/or 1280×1024 pixels. In one additional variant of the device and method described above, image columns are recorded instead of image lines. The at least one infrared-sensitive camera used in the exemplary embodiments described has a linear exposure characteristics line and/or a logarithmic exposure characteristics line.

The pulse duration and/or the cycle of the light pulse are generally adapted, depending on the exemplary embodiment, to the timing of the at least one camera and/or the time response of at least one pixel of the at least one camera. The timing of the camera is determined by the frame rate and/or the line synchronization signal and/or the pixel clock. At a frame rate of, say, at least 25 images per second, depending on the matrix size of the infrared-sensitive cameras, a pixel clock between 4 MHz to 20 MHz is present. Depending on the matrix size of the infrared-sensitive camera, the cycle of the light pulse, corresponding to the line synchronization signal, amounts to between 50 μs and 100 μs. By time response of a pixel is meant the output signal of the pixel with respect to a short rectangular light pulse. In order to operate the pulsed emission source, that radiates in the near infrared spectral region, with as high as possible a peak irradiation power, the duty cycle is selected to be as small as possible, preferably less than 0.1%. Conditioned on the transient response of the pixel, the pulse duration of the light pulse is selected so that the pulse duration amounts to approximately one pixel frequency. Depending upon the matrix size of the infrared-sensitive camera, the pulse duration of the light pulse is preferable selected to be between 50 ns to 200 ns.

One variant of the example device and method described above, besides using the one emission source radiating in the near infrared spectral region, uses at least one additional emission source radiating in the near infrared spectral region. Alternatively or in supplement, at least one laser radiating in the near infrared spectral region is used. In general, one may use at least one emission source radiating in the near infrared spectral region, which is suitable for the pulsed output of infrared radiation at least in the near infrared region.

1-10. (canceled)

11. A device for image generation in a motor vehicle, comprising:
at least one infrared-sensitive camera configured to generate at least one image of surroundings of the motor vehicle;
at least one emission source radiating at least in a near infrared spectral region for a pulsed illumination of an image recording region of the at least one infrared-sensitive camera; and
an arrangement configured to record the at least one image line by line in scanning lines, and to carry out a synchronization in time of the recording of the scanning lines with the pulsed illumination.

12. The device as recited in claim 11, wherein the at least one infrared-sensitive camera is at least one infrared-sensitive CMOS camera.

13. The device as recited in claim 11, wherein the at least one emission source radiating at least in the near infrared spectral region is at least one of: i) at least one infrared-radiating laser, and ii) at least one infrared-radiating laser diode.

14. The device as recited in claim 11, wherein the at least one emission source radiating at least in the near infrared spectral region includes an arrangement configured to output light pulses having a pulse duration adapted to a time response of at least one pixel of the camera.

15. The device as recited in claim 14, wherein the light pulses have a pulse duration between 50 ns and 200 ns.

16. The device as recited in claim 11, further comprising:
an arrangement carrying out the synchronization in time scanning at least one of line by scanning line, image by image, and image sequence by image sequence.

17. The device as recited in claim 11, wherein the at least one infrared-sensitive camera has an arrangement configured to carry out the synchronization in time with the pulsed illumination autonomously.

18. A method for image generation in a motor vehicle, comprising:
generating, by at least one infrared-sensitive camera, at least one image of surroundings of the motor vehicle;
in a pulsed manner at least in the near infrared spectral region, illuminating by at least one emission source an image recording region of the at least one infrared-sensitive camera; and
recording the at least one image line-wise in scanning lines and synchronizing in time the recording of the scanning lines with the pulsed illumination.

19. The method as recited in claim 18, wherein the at least one emission source includes at least one of an infrared radiating laser and an infrared-radiating laser diode.

20. The method as recited in claim 18, wherein the infrared-sensitive camera is an infrared-sensitive CMOS camera.

21. The method as recited in claim 18, wherein the at least one emission source radiating at least in the near infrared spectral region outputs light pulses having a pulse duration adapted to the time response of at least one pixel of the camera.

22. The method as recited in claim 21, wherein the at least one emission source output light pulses having a pulse duration between 50 ns and 200 ns.

23. The method as recited in claim 18, wherein the synchronization in time is carried out scanning at least one of line-wise, image-wise, and image sequence-wise.

24. The method as recited in claim 18, wherein the at least one infrared-sensitive camera autonomously synchronizes itself with the pulsed illumination.
